(19) United States
(12) Patent Application Publication
(10) Pub. No.: US 2002/0110639 A1
(43) Pub. Date: Aug. 15, 2002

(54) Epoxy coating for optical surfaces

(76) Inventor: Donald Bruns, San Diego, CA (US)

Correspondence Address: EASTMAN & ASSOCIATES, Suite 306, 520 West Ash Street, San Diego, CA, 92101, US

(21) Appl. No.: 09/960,266

(22) Filed: Sep. 20, 2001

Related U.S. Application Data
(63) Continuation-in-part of application No. 09/875,447, filed on Jun. 4, 2001.
(60) Provisional application No. 60/253,418, filed on Nov. 27, 2000.

(51) Int. Cl. B05D 5/06

(52) U.S. Cl. 427/162; 359/580

(57) ABSTRACT

A method and device for coating an optical surface is disclosed. In one embodiment, a thin film epoxy coating may be formed on an optical element, such as by depositing a layer of light reactive epoxy (e.g., an optical material comprising a monomer and at least one polymerization initiator) onto a surface of the optical element (e.g. a lens). The layer of epoxy may then be illuminated with a light source, which may cause a portion of the epoxy layer to cure and adhere to the optical element. This may result in the formation of an anti-reflection coating on the optical element. Lastly, any of the epoxy layer that did not cure and adhere to the optical element may be removed so that the optical element permits light transmission.

### RELATED APPLICATIONS

This application is a continuation-in-part of pending utility patent application entitled “WAVEFRONT ABERRATOR AND METHOD OF MANUFACTURING”, Ser. No. 09/875,447, filed Jun. 4, 2001, which is a continuation-in-part of pending provisional application entitled “WAVEFRONT ABERRATOR”, serial number 60/253,418, filed Nov. 6, 2000.

### FIELD OF THE INVENTION

The present invention relates to coatings for optical devices, and in particular, to an ultra violet (UV) reactive coating that may be formed on an optical device, such as a lens.

### BACKGROUND OF THE INVENTION

Presently, optical devices may be formed with some type of coating material in an attempt to enhance their optical characteristics, such as the reduction of light reflection and ghost images. Typical optical devices include lenses and eyepieces that may be used in devices, such as telescopes, binoculars, microscopes, and the like. It is particularly useful for any coating formed on these optical devices to be transparent, or at least semi-transparent. Currently available methods and systems produce optical devices with some type of coating material, but these systems have several drawbacks.

For example, one method of applying thin films to substrates utilizes a spin coating system. A spin coating system produces centrifugal forces created by spinning an object, such as a substrate, at some predetermined speed. While the substrate is spinning, a coating solution is applied to the surface of the substrate. The spin coating system utilizes centrifugal forces to spread the coating solution across the surface of the substrate. Although this type of system may be practical for some kinds of applications, it requires expensive spin casting machinery and does not always provide a uniform thickness of the coating material. For example, the spin coating system may generate a surface coating that is thinner at the inside diameter and steadily increasing as the coating material approaches the outside diameter of the substrate.

Another method of applying thin films to substrates utilizes a system having a vacuum chamber, such as chemical vapor deposition (CVD) devices. In these types of devices, a coating process is performed in which the coating material is applied to a substrate within the vacuum chamber. During the process, the coating material may be vaporized and transported across the chamber where at least a portion of the material is condensed upon the substrate. This process typically results in the deposition of thin films with a reasonable degree of accuracy. However, similarly to the spin coating system, the vacuum chamber systems are labor intensive and require costly machinery to produce thin film coated devices.

An additional drawback of the spin coating and vacuum chamber systems is that the size of the devices that are to be coated is limited by the size of the machine. In particular, only devices that may fit into each of these respective systems may be formed with a coating material.

In view of the foregoing, a present need exists for a coating material that may be formed on an optical device to enhance its optical characteristic. Additional need exists for a coating material that does not rely up expensive systems, such as the spin coating and vacuum chamber systems, in order for the material to be applied.

### SUMMARY OF THE INVENTION

The thin film coating method and device of the present invention includes a thin film epoxy coating that may be formed on an optical element. The coating may be formed, for example, by depositing a layer of light reactive epoxy (e.g., an optical material comprising a monomer and at least one polymerization initiator) onto a surface of the optical element (e.g. a lens). Next, the layer of epoxy may be illuminated with a light source, which may cause a portion of the epoxy layer to cure and adhere to the optical element. This may result in the formation of an anti-reflection coating on the optical element. Lastly, any of the epoxy layer that did not cure and adhere to the optical element may be removed so that the optical element permits light transmission.

In accordance with one aspect of the present invention, the thickness of the anti-reflection coating is at least about 0.01 mil thick.

In accordance with another aspect of the present invention, the thickness of the anti-reflection coating on the optical element ranges from about 0.01 mil to about 50 mil thick.

In still yet another aspect of the present invention, an elapsed time of illumination is based one or more factors, such as a desired thickness of the anti-reflection coating on the optical element, an intensity of the light source, and/or a refractive index of the optical element.

In yet another aspect of the present invention, the anti-reflection coating on the optical element minimizes light reflections and/or ghost images produced by the optical element, as compared to an optical element that does not have the anti-reflection coating.

In still yet another aspect of the present invention, the light source illuminates the layer of epoxy through the optical element.

In accordance with another aspect of the present invention, the layer of epoxy comprises a coloring agent so that the anti-reflection coating comprises color.

In accordance with another aspect of the present invention, the light source may be a laser, a light emitting diode (LED), or some type of light emission device that produces ultraviolet (UV) light.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a diagram illustrating an exemplary configuration of some of the major components of a system that may be used to form a coating material upon an optical device;

FIGS. 2A-2D illustrate several stages that an optical device may undergo while having a coating material formed upon the device;

FIG. 3 is a graph illustrating the correlation between the thickness of the cured coating material and the elapsed time that the coating material is exposed to light; and

FIG. 4 is a flowchart illustrating some of the operations that may be used to form a coating material on an optical device.

### DETAILED DESCRIPTION OF A PREFERRED EMBODIMENT

In the following description of a preferred embodiment, reference is made to the accompanying drawings, which form a part hereof, and which show by way of illustration a specific embodiment of the invention. It is to be understood by those of working skill in this technological field that other embodiments may be utilized, and structural as well as procedural changes may be made without departing from the scope of the present invention.

Overview of a Material Coating System

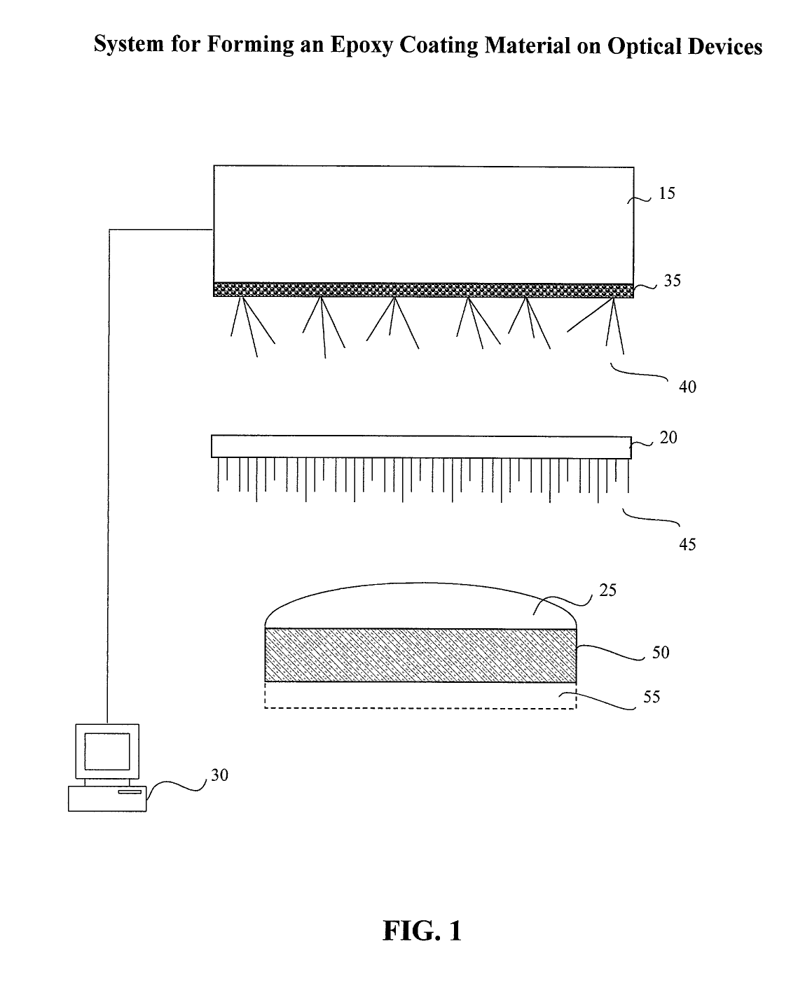

Referring initially to FIG. 1, an exemplary configuration of an epoxy curing system is shown and generally designated 10. Curing system 10 is one type of curing system that may be used to form a coating material upon an optical device. This Figure shows coating system 10 comprising illumination unit 15, a diffuser 20, optical device 25, as well as a computer 30 that is in communication with the illumination unit 15.

Illumination unit 15 may comprise, for example, a light source 35 which may produce light beams 40. In one embodiment, light source 35 produces a constant fluence light having a constant intensity across the illuminated surface of the light. For example, light source 35 may contain an array of LEDs, or any other suitable source of illumination (e.g., laser).

A diffuser 20 is shown disposed between the illumination unit 15 and the optical device 25. One purpose of the diffuser 20 is to smooth out the light beams 40, resulting in light rays 45 which may be more uniform in intensity. Diffuser 20 may comprise most any of the known diffusing elements. However, it is to be understood that a diffusing element is not required to form the optical surface coating of the present invention because the light source 35 typically provides sufficient illumination.

Although a substantially constant intensity light pattern is shown, the present invention is not so limited. For example, illumination unit 15 may selectively illuminate particular portions of light source 35 (e.g., individual LEDs). This may result in the selective curing of epoxy layer 50. This selective curing aspect may create a curing thickness of the epoxy layer 50 that corresponds to the time and intensity of the exposure to the light source 35.

This selective curing therefore may result in an optical device having different thicknesses of cured epoxy across the exposed surface. Thus, by varying the intensity and period of illumination of light source 35, for example, the optical device 25 may be formed with a variable thickness of cured epoxy (not shown). However, it is often useful to provide a cured epoxy layer having a substantially uniform thickness. Accordingly, while it is possible to provide an optical device with an cured epoxy layer having a variable thickness, a typical optical device of the present invention comprises a cured epoxy layer that is substantially uniform in thickness.

In one embodiment, optical device 25 comprises an epoxy layer 50 and a transparent cover 55. In this configuration, optical device 25 is spherically shaped and may possesses varying degrees of focusing powers (e.g., an optical lens). Although a spherically shaped optical device is shown, it is to be understood that optical devices of various sizes, shapes, and focusing powers may also be used. For example, optical device 25 may be constructed as a cylindrical (astigmatism) lens. Additionally, optical device 25 may be constructed of any of the known optical device construction materials, such as glass, plastic, and the like.

Sandwiched between the optical device 25 and the transparent cover 55 is epoxy layer 50. Typically, epoxy layer 50 includes a light-curable resin comprised of monomers and polymerization initiators, such that the resin begins to cure upon exposure to light (e.g., light beams 40 or light rays 45). Because of this curing process, the cured epoxy acts as an adhesive, and therefore at least a portion of cured epoxy adheres to the surface of the optical device 25.

Generally, the extent of resin curing may be affect by several factors, such as light intensity, duration of light exposure, amount and type of resin present, etc. More specifically, the extent of resin curing may be determined by the percentage of cross-linking between the monomers within the epoxy. Suitable resins include VLE-4101 UV-Visible Light Cure Epoxy, available from Star Technology, Inc., or Optical Adhesive #63, U.V. Curing, available from Norland Products, Inc. Typically, these resins are curable by exposure to UV or visible light radiation in the range of 300 to 550 nanometers (300-550 nm). However, the present invention is not limited to a particular resin or a particular wavelength of light. As such, most any type of epoxy that is curable by exposure to light, as well as any wavelength of light (e.g, 300 nm to 3000 nm), is contemplated by the present invention.

Additional resins which may be cured upon exposure to light include monomers that polymerize into long-chain molecules using photo-initiators. Any of these types of resins may also be used in the present invention. For example, a suitable monomer may be chosen from the family of epoxides, urethanes, thiol-enes, acrylates, cellulose esters, or mercapto-esters, and a broad class of epoxies. Also, for example, a suitable photo-initiator may be chosen from chosen from alpha cleavage photoinitiators such as the benzoin ethers, benzil ketals, acetophenones, or phosphine oxides, or hydrogen abstraction photoinitiators such as the benzophenones, thioxanthones, camphorquinones, or bisimidazole, or cationic photoinitiators such as the aryidiazonium salts, arylsulfonium and aryliodonium salts, or ferrocerium salts. Alternatively, other photoinitiators such as the phenylphosphonium benzophene salts, aryl tert-butyl peresters, titanocene, or NMM may be used.

It should also be realized that any of the resins utilized in the present invention may include a color tinting agent (e.g., red, green, blue, etc.), which may provide for a cured epoxy having some degree of coloring, if so desired.

It is also to be understood that in addition to the above-described curing properties of the resin(e.g., variable curing thicknesses), the refractive index of the resin may also change as the resin is cured. As such, the refractive index of the resin may vary between locations within the resin layer depending on the extent of epoxy curing.

Accordingly, in one embodiment of the present invention, a light source containing a particular wavelength irradiates the monomer layer which activates the photo-initiator and begins the curing process within the epoxy (e.g., epoxy layer 50). The curing process may result in a curing of at least a portion of epoxy layer 50, and may even result in a corresponding change of the index of refraction within the resin. However, it is also to be appreciated that terminating the exposure to the particular wavelength of light ceases the curing of the epoxy, and ceasing the change of the index of refraction exhibited by the epoxy. In this manner, an optical device 25, and epoxy layer 50, may be exposed to a light source which may be varied (e.g., duration, intensity, position, etc.), resulting in an optical device 25 having a cured layer of epoxy (not shown in this Figure).

In one embodiment, the optical device 25 comprises a cover 55, which may be used to contain the epoxy layer 50 during a curing process. Cover 55 may be formed from a rigid material, such as glass or plastic, and may be either transparent or opaque. While glass provides a stable platform, such rigidity is not necessary. In fact, cover 55 may be constructed from a flexible material, such as a transparent polymer. A suitable polymer may include, for example, mylar film, polycarbonate film, or acetate film.

For reasons that will become clear, it is particularly useful for cover 55 to be removable after epoxy layer 50 has been cured. As such, cover 55 may be formed from a removable material, such as a dissolvable salt. Thus, after a curing process has occurred, and at least a portion of epoxy layer 50 has been cured, cover 55 may be removed (e.g., dissolving the salt cover). The dissolving nature of cover 55 provides for an exposed epoxy layer facilitating post curing treatment of the epoxy layer that will be described in more detain herein.

Cover 55 may also be formed using other methods. For example, cover 55 may be constructed with an organic material which may be dissolved, for example, in an organic solvent. However, it is to be understood that the present invention is not limited to a cover that is of a particular size, shape, or material. Thus, most any type of covering material or device may be used. Additionally, it should also be realized that the present invention does not require the covering of epoxy layer 50 during the curing process, and therefore cover 55 is not always required to form a coating on the optical device.

Referring still to FIG. 1, computer 30 may comprise, for example, an appropriate computer, display, as well as any of a variety of other types of input and/or output devices. Appropriate computers that are compatible with the present invention include handheld computing devices, personal computers, server based workstations, portable computers, as well as any other type of computing device that can control the illumination unit 15. It is to be noted, that the curing stage will be described with reference made to computer 30. However, the present invention is not dependent upon the use of a computer and some or all of the calculations performed during this process (e.g., time of the illumination, processing, etc.), may be performed manually.

Optical Device During Various Stages of Material Coating

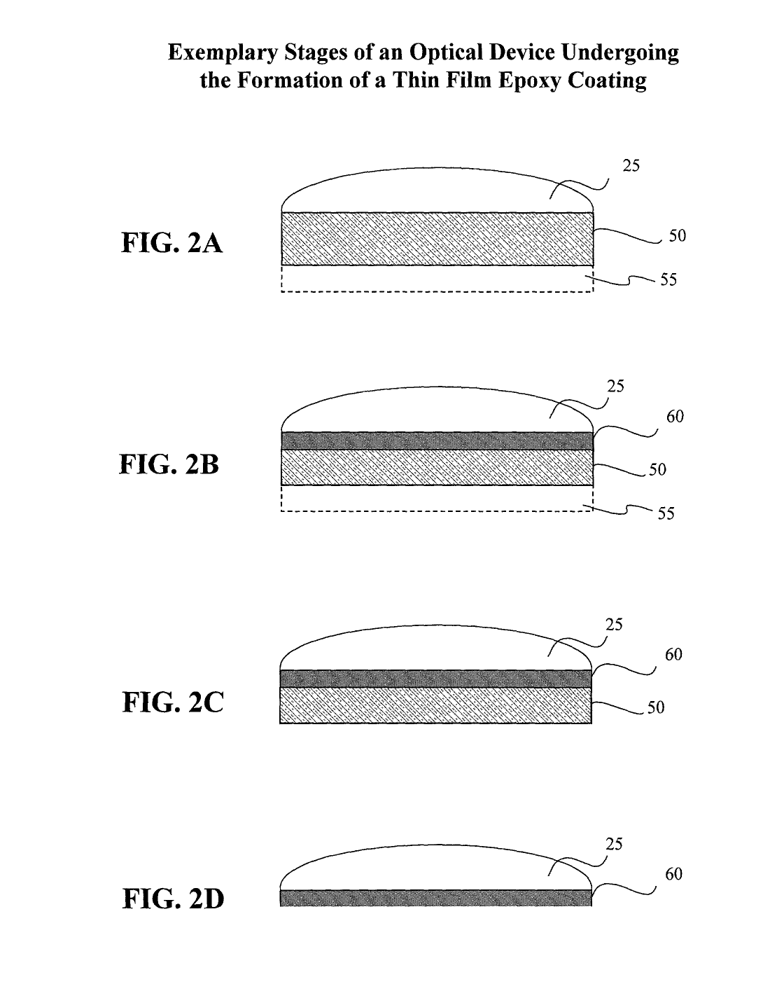

Referring now to FIGS. 2A-2D, several exemplary stages that an optical device may undergo while having a coating material (e.g., UV reactive epoxy) formed upon the device. FIG. 2A shows an optical device 25 as it may appear prior to a curing process (e.g., before exposure to light beam 40). More particularly, an uncured layer of epoxy (i.e., epoxy layer 50) is shown coating a surface of optical device 25, and being contained by cover 55. Again, cover 55 may be used to facilitate the curing process, but is not essential to the present invention.

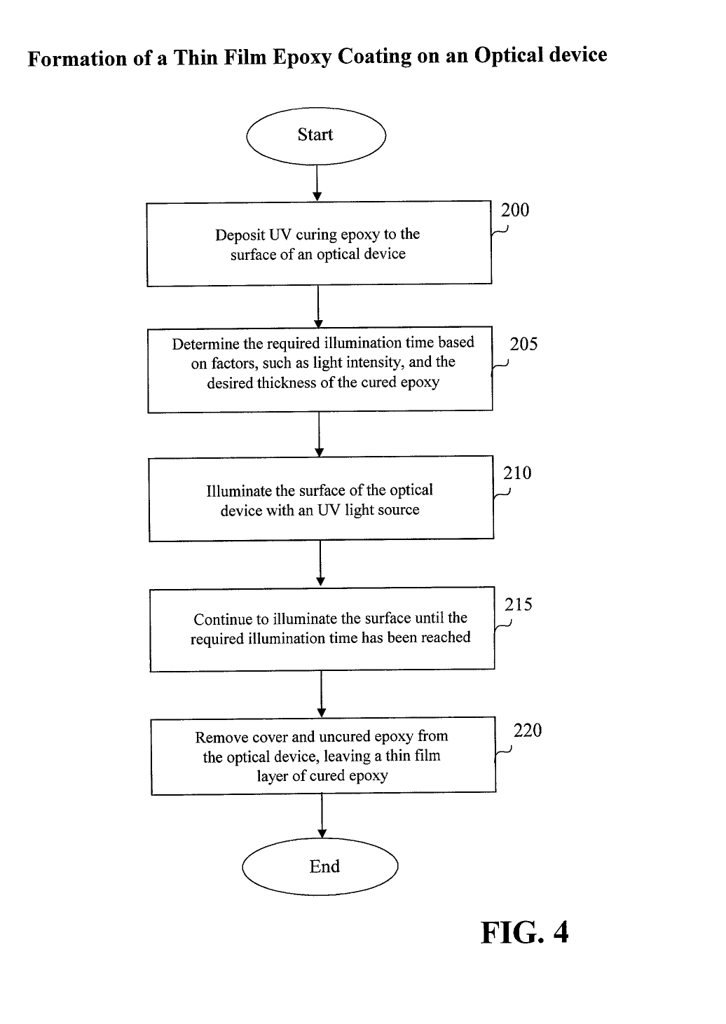

FIG. 2B shows an example of an optical device 25 after at least a limited exposure to light, such as light rays 45. In this Figure, a portion of epoxy layer 50 has been cured by the exposure to the light, creating cured epoxy 60 that has become adhered to the surface of optical device 25. The thickness of cured epoxy 60 may vary as compared to the thickness of epoxy layer 50. For example, the thickness of cured epoxy 60 may range to from only a fractional portion of epoxy layer 50 or may comprise the entire epoxy layer 50. In other words, a small portion of epoxy layer 50 may be cured (as shown in FIG. 4B), or the entire epoxy layer 50 may be cured (not shown).

As discussed previously, the thickness of the cured epoxy 60 may be affected by several factors, such as light intensity, duration of light exposure, amount and type of resin present, the refractive index of optical device 25, the existence of the diffuser 20, etc. For example, by increasing the intensity of light source 35, the thickness of the cured epoxy 60 may also increase. Similarly, increasing the duration that the optical device 25 is exposed to light source 35 may result in an increase in the thickness of the cured epoxy 60. As such, it is to be realized that a particular or desired thickness of cured epoxy 60 may be obtained by increasing or decreasing the duration and/or intensity of light source 35.

One embodiment of the present invention provides an optical device having an optical coating that does not substantially impair the optical quality of the device. Thus, it is often useful to cure the epoxy layer in such a manner that the thickness of the cured epoxy is minimized. In other words, it may be advantageous to control the intensity and/or duration of illumination that the epoxy layer 50 experiences so that the thickness of cured epoxy 60 is minimized. It is to be realized that the present invention does not require a particular thickness of the cured epoxy, and any thickness range (e.g., 0.01-50 mil) may be used.

FIG. 2C shows an optical device 25 with an exposed epoxy layer 50, with cover 55 having been removed. As described previously, cover 55 may comprise a removable material, such as a dissolvable salt or organic material. Accordingly, the optical device 25 shown in this Figure may have undergone the appropriate post-curing processing to remove the cover 55.

Referring now to FIG. 2C, an optical device 25 is shown having a cured layer 60, with epoxy layer 50 having been removed. Since epoxy layer 60 was not cured (i.e., not illuminated sufficiently), it may easily be removed by using any known epoxy removal technique (e.g., water, detergents, solvents, etc.) Accordingly, the optical device 25 shown in FIG. 2C represents an optical device having a thin film, cured epoxy coating that may possess enhanced optical characteristics (e.g., minimization of reflections and ghost images, etc.)

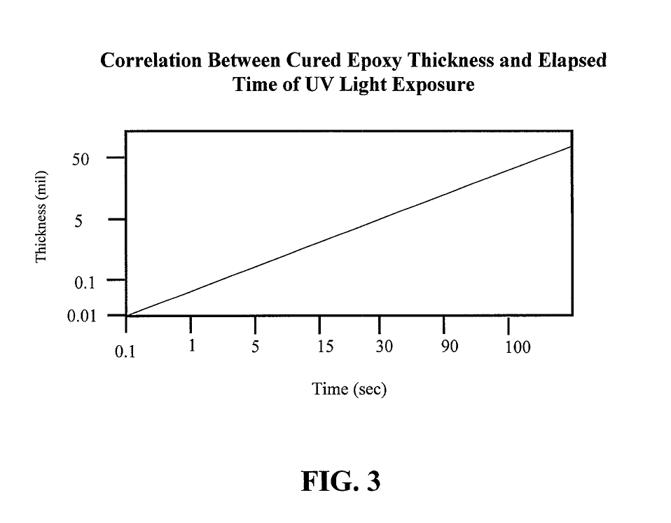

Referring now to FIG. 3, a graph illustrating the correlation between the thickness of the cured epoxy 60 and the elapsed time of exposure is shown. It is to be understood that while the data represented in this graph is exemplary, the present invention is not limited to this data and that different illumination times and thickness may occur.

The graph shown in FIG. 3 illustrates one method for controlling the thickness of cured epoxy 60. For example, to obtain a cured epoxy layer of approximately 0.1 mil, an exposure time of about two seconds may be used. However, should a cured epoxy layer of approximately 50 mil be desired, the epoxy should be exposed for about 100 seconds. As such, a cured epoxy layer with a predefined thickness may be formed on an optical device by controlling the elapsed illumination time. Thus, the optical device 25, in combination with cured epoxy layer 60, may provide for an optical element having focusing as well as enhanced optical characteristics.

Thin Film Coating Process

One embodiment of the present invention provides an optical device with a thin film layer of a cured epoxy coating. On aspect of the cured epoxy coating is that it enhances the performance of the optical device by, for example, reducing light reflections and ghost images. An exemplary method for forming a cured epoxy coating on an optical device will now be described, with reference made to the flowchart shown in FIG. 4.

In FIG. 4, operation 200, UV curing epoxy 50 may be applied to one surface of the optical device 25. The optical device 25 may then optionally be configured with some type of cover so that the curing epoxy may be contained during the curing process. An example e of an optical device so configured is show n in FIG. 2A. Specifically, optical device 25 with epoxy layer 50 contained by cover 55 is shown.

As previously described, the present invention is not limited to a particular thickness of the epoxy layer. Thus, while an uncured epoxy layer of about 1 mil in thickness may be used, this uncured epoxy layer may range anywhere from 0.01 mil to 5 mm, or even more.

Another operation that may be performed is to determine the illumination time that the optical device 25, as well as the epoxy layer 50, are to undergo illumination (operation 205). Factors that may be considered include the desired thickness of the cured epoxy (e.g., cured epoxy 60), light intensity, thickness and type of epoxy present (e.g., epoxy layer 50), the refractive index of optical device 25, as well as the existence of a diffuser. The light intensity may be determined, for example, by sampling or monitoring the intensity of light source 35. The thickness of the epoxy layer 50 may be measured by an appropriate measuring device.

Once any required factors have been determined, they may be entered into the computer 30, for example, so that the illumination time may be calculated. Illumination time may be calculated by using the above-described factors as well as data from a graph, such as the one shown in FIG. 3. Again, some or all of the calculations, illumination control, etc., may be performed manually.

Once the epoxy layer 50 has been applied, the illumination time has been calculated, and the cover (if used) has been secured, the optical device 25 may then undergo illumination.

At this point, computer 30, for example, may initiate the illumination of light source 35, resulting in the generation of light beams 40 (operation 210). The light beams 40 may then be diffused by diffuser 20, resulting in light rays 45. Light rays 45 may then propagate through optical device 25 and strike a surface of epoxy layer 50. It is to be noted that if a diffuser is not used, then light beams 40 would strike the surface of epoxy layer 50.

Light source 35 may continue to provide illumination until the calculated illumination time has elapsed (operation 210). It is to be understood that once the illumination of the epoxy layer 50 has ceased, the curing of the epoxy layer 50 also ceases. Put another way, once a desired thickness of the cured epoxy 60 has been obtained, illumination is terminated to prevent further curing of the epoxy layer 50. An example of an optical device that has undergone a typical illumination process is shown in FIG. 2B. This Figure shows optical device 25 with a layer of cured epoxy 60 and uncured epoxy layer 50, which are both contained by cover 55.

Referring back now to FIG. 4, the next operation that may be performed is the removal of cover 55 (if used), and any uncured epoxy (i.e., epoxy layer 50) from the optical device 25 Again, cover 55 and the uncured epoxy layer 50, may be removed by using any known methods (e.g., water, detergents, solvents, etc.)

An example of an optical device that has undergone a typical illumination process, as well as the cover and uncured epoxy removal processes, is shown in FIG. 2D. More particularly, FIG. 2D shows an example of an optical device 15 having a cured layer of epoxy 60.

The thin film epoxy coating of the present invention may be used to provide enhanced optical characteristics to any of a variety of optical devices. For example, the present invention may be useful in a variety of different optical systems by forming the epoxy coating onto devices, such as eyepieces used in telescopes, binoculars, or microscopes. In fact, most any type of lens or even mirror based optical system may be configured with the epoxy coating of the present invention. Additional uses include devices where the reduction or elimination of light reflection or ghost images is desired, such as computer display screens, CRT displays, LCD screens, scanners, photocopiers, and the like.

While there have been shown what are presently considered to be preferred embodiments of the present invention, it will be apparent to those skilled in the art that various changes and modifications can be made herein without departing from the scope and spirit of the invention.

What is claimed is:

1. A method for forming a thin film coating on an optical element, said method comprising:
depositing a layer of optical material comprising a monomer and at least one polymerization initiator onto a surface of said optical element;
illuminating said layer of optical material with a light source causing at least a portion of said optical material to cure and adhere to said optical element, resulting in an anti-reflection coating on said optical element; and
removing any of said optical material that did not cure and adhere to said optical element so that said optical element permits light transmission.

2. The method according to claim 1, wherein a thickness of said anti-reflection coating on said optical element is at least about 0.01 mil thick.

3. The method according to claim 1, wherein a thickness of said anti-reflection coating on said optical element ranges from about 0.01 mil to about 50 mil thick.

4. The method according to claim 1, wherein an elapsed time of said illuminating is based on a desired thickness of said anti-reflection coating on said optical element.

5. The method according to claim 1, wherein an elapsed time of said illuminating is based on at least one factor selected from the group consisting of a desired thickness of said anti-reflection coating on said optical element, an intensity of said light source, and a refractive index of said optical element.

6. The method according to claim 1, said method further comprising:
utilizing a removable cover to contain said optical material during said illuminating.

7. The method according to claim 1, wherein said anti-reflection coating on said optical element minimizes light reflections produced by said optical element as compared to an optical element that does not have said anti-reflection coating.

8. The method according to claim 1, wherein said light source illuminates said layer of optical material through said optical element.

9. The method according to claim 1, wherein said optical material comprises a coloring agent so that said anti-reflection coating on said optical element comprises color.

10. The method according to claim 1, wherein said optical material is epoxy.

11. The method according to claim 1, wherein said light source is a laser.

12. The method according to claim 1, wherein said light source is a light emitting diode (LED).

13. The method according to claim 1, wherein said light source emits ultraviolet (UV) light.

14. An anti-reflection optical element comprising:
an optical surface; and
a layer of cured epoxy defining an anti-reflection coating, wherein said layer of cured epoxy is formed on said optical surface by a method comprising:
depositing a layer of light reactive epoxy onto said optical surface;
illuminating said layer of light reactive epoxy with a light source, causing said layer of cured epoxy to form on said optical surface; and
removing any of said layer of light reactive epoxy that did not cure so that said anti-reflection optical element permits light transmission.

15. The optical element according to claim 14, wherein a thickness of said anti-reflection coating on said optical surface is at least about 0.01 mil thick.

16. The optical element according to claim 14, wherein a thickness of said anti-reflection coating on said optical surface ranges from about 0.01 mil to about 50 mil thick.

17. The optical element according to claim 14, wherein an elapsed time of said illuminating is based on a desired thickness of said anti-reflection coating on said optical surface.

18. The optical element according to claim 14, wherein an elapsed time of said illuminating is based on at least one factor selected from the group consisting of a desired thickness of said anti-reflection coating on said optical surface, an intensity of said light source, and a refractive index of said optical element.

19. The optical element according to claim 14, further comprising:
a removable cover to contain said layer of light reactive epoxy.

20. The method according to claim 14, wherein said anti-reflection coating on said optical surface minimizes light reflections produced by said optical element as compared to an optical element that does not have said anti-reflection coating.

21. The optical element according to claim 14, wherein said anti-reflection coating on said optical surface minimizes ghost images produced by said optical element as compared to an optical element that does not have said anti-reflection coating.

22. The optical element according to claim 14, wherein said light source illuminates said layer of light reactive epoxy through said optical surface.

23. A method for forming a thin film epoxy coating on an optical element, said method comprising:
depositing a layer of epoxy onto a surface of said optical element, wherein said epoxy is light reactive;
illuminating said layer of epoxy with a light source causing at least a portion of said layer of epoxy to cure and adhere to said optical element, resulting in an anti-reflection coating on said optical element; and
removing any of said layer of epoxy that did not cure and adhere to said optical element so that said optical element permits light transmission.

24. The method according to claim 23, wherein a thickness of said anti-reflection coating on said optical element is at least about 0.01 mil thick.

25. The method according to claim 23, wherein a thickness of said anti-reflection coating on said optical element ranges from about 0.01 mil to about 50 mil thick.

26. The method according to claim 23, wherein an elapsed time of said illuminating is based on a desired thickness of said anti-reflection coating on said optical element.

27. The method according to claim 23, wherein an elapsed time of said illuminating is based on at least one factor selected from the group consisting of a desired thickness of said anti-reflection coating on said optical element, an intensity of said light source, and a refractive index of said optical element.

28. The method according to claim 23, said method further comprising:
utilizing a removable cover to contain said layer of epoxy during said illuminating.

29. The method according to claim 23, wherein said anti-reflection coating on said optical element minimizes light reflections produced by said optical element as compared to an optical element that does not have said anti-reflection coating.
